(19) United States
(12) Patent Application Publication
(10) Pub. No.: US 2017/0124923 A1
(43) Pub. Date: May 4, 2017

(54) Towel Twirler

(71) Applicants: Jeffery Alan Gray, Lawrenceville, IL (US); Joshua Alan Gray, Lawrenceville, IL (US)

(72) Inventors: Jeffery Alan Gray, Lawrenceville, IL (US); Joshua Alan Gray, Lawrenceville, IL (US)

(21) Appl. No.: 14/929,551

(22) Filed: Nov. 2, 2015

(51) Int. Cl. G09F 17/00

(52) U.S. Cl. CPC G09F 17/00; G09F 2017/0008

(57) ABSTRACT

The present invention generally relates to a towel twirling device. The present invention provides a towel twirling device for twirling a towel without wrapping it around the hand, thus allowing extended twirling of the towel. The towel twirling device is made of a round tube with a rounded head to which a towel holding clip is attached. The towel twirling device also connects the device to a belt loop, pocket, or bottom of a shirt, to hang the towel twirling device with clipped towel when the towel is not to be twirled.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention generally relates to a towel twirling device. More particularly, the present invention relates to “a towel twirling device for twirling a towel without wrapping or bundling it around the hand. The towel twirling device also allows the device to connect to a belt loop, pocket, or bottom of a shirt to hang the towel twirling device with a clipped towel when the towel is not being twirled”.

(2) Background of the Invention

Twirling towels is a fun activity people do at sporting events, rallies, and other types of events to show support. Some apparatuses have been made for twirling towels. Rally towel devices or towel twirling devices are sold or given for free at stadiums during an event. The towel is twirled by the rotation of the wrist. For example, U.S. Pat. No. 8,136,209 B1, issued to Willison Christopher H on 2012, Mar. 20, discusses a spinner handle comprised of an ergonomic elongated cylindrical handle and a banner-towel grasping attachment made of two parts attached by hinges to hold a banner-towel placed there between for waving a sport's fan banner-towel. Similarly, U.S. Pat. No. 8,257,135 B2 issued to Arcovio Andrew M on 2012, Sep. 4, discloses a spinning towel assembly that includes a grip by which the user may hold the assembly. Between the grip and the towel, there is a collar that allows the towel to rotate about an axis. The axis of rotation is a pin that holds the grip to the towel. The pin connects through the collar on the towel in a position that allows rotation. However, one major problem in twirling towels is that the towel tends to wrap around and bundle up around the hand of the person, and the person has to stop twirling to untangle the towel. This affects the comfort of the act of twirling towels. Hence, it is desirable to have a device that allows efficient twirling of towels while preventing the towel from wrapping around the hand, so that the towel can be twirled for an extended period of time. Another issue with rally towels and towel twirling devices is that when the person doesn't need to twirl the towel, the towel and the rally towel device has to be held in the hand, which may cause discomfort. Alternatively, the person may keep them in a nearby spot in the stadium or event location, resulting in the lose of the towel and the towel spinning device. Hence, there is a need to provide a way to carry the rally towel and the towel twirling device efficiently and comfortably when the rally towel is not to be twirled.

It is an objective of the invention to overcome or alleviate a problem of the prior art.

This permits the use of the present invention, which enhances the prior art of towel twirling devices for twirling towels without wrapping them around the hand. The towel twirling device carries the clipped towel from a belt loop, pocket, or bottom of a shirt when the towel is not to be twirled.

### SUMMARY OF THE INVENTION

In view of the foregoing, one aspect of the various disclosed embodiments of the present invention is to provide a towel twirling device for twirling a towel without wrapping it around the hand.

Preferably, the towel twirling device addresses, or at least ameliorates, one or more of the problems described above. To this end, the present invention, related to a towel twirling device with some unique aspects, is disclosed.

Accordingly, it is a primary objective of the present invention to provide a towel twirling device for twirling a towel without wrapping it around the hand, thus allowing extended twirling of the towel. The towel twirling device is made of a round tube with a rounded head to which a towel holding clip is attached.

It is another objective of the present invention that the towel twirling device also connects the device to a belt loop, pocket, or bottom of a shirt, to hang the towel twirling device with clipped towel when the towel is not to be twirled.

It is yet another objective of the present invention that the towel twirling device is made of lightweight material, such as plastic, to allow comfort while twirling a towel.

Other objectives of the present invention will become apparent from time to time throughout the specification, as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1 shows a perspective view of a towel twirling device.

FIG. 2 shows a perspective view of a towel twirling device with an additional hollow cylinder functioning as handle.

### DETAILED DESCRIPTION OF THE INVENTION

The following detailed description of the present invention enables teaching of the invention and its best, currently known embodiment. Those skilled in the art can understand that many changes can be made to the embodiments described, while still obtaining the beneficial results of the present invention. It will also be apparent that some of the desired benefits of the present invention can be obtained by selecting some of the features of the invention while not utilizing other features. Accordingly, those working in the relevant art will recognize that many adaptations and modification to the present invention can be made, may be desired in certain circumstances, and are part of the present invention. Thus, the following description is provided as illustrative of the principle of the present invention.

Embodiments of the present invention provide a towel twirling device for twirling a towel without wrapping it around the hand. The towel twirling device also connects to a belt loop, pocket, or bottom of a shirt to hang said towel twirling device with a clipped towel when the towel is not to be twirled. Accordingly, the specific embodiments discussed herein are merely illustrative of specific manners in which to make and use this invention, and are not intended to represent an exhaustive list of all possible structure and processes of the present invention.

Embodiments of the method are shown in the figures, and discussed below. While the structure and processes have been described with a certain degree of particularity, it is to be noted that many modifications may be made in the details of the structure and processes without departing from the spirit and scope of this disclosure. It is understood that the structure and processes are not limited to the embodiments, set forth herein for purposes of exemplification.

Aspects of the present inventive subject matter are described with reference to the figures provided herein.

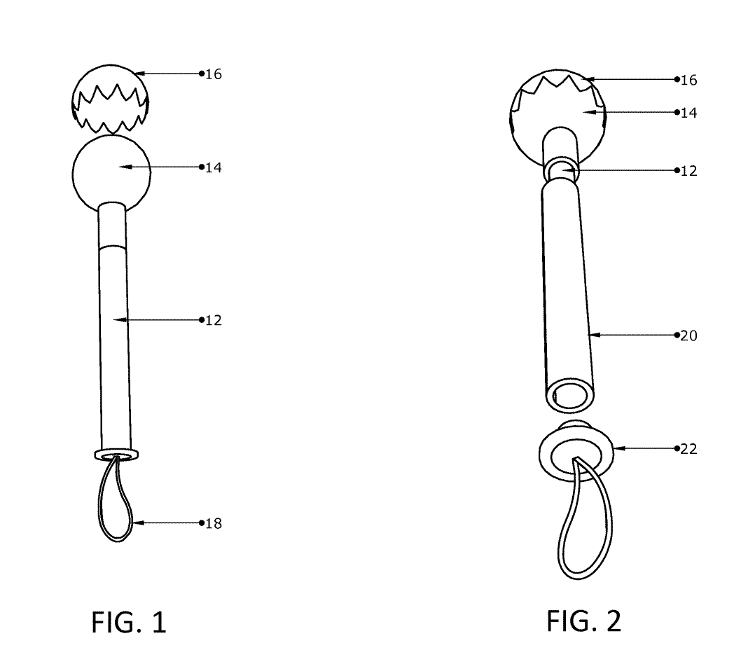

FIG. 1 illustrates an exemplary representation of a towel twirling device. The towel twirling device has a round tube 12 that functions as a handle. The round tube 12 has a rounded head 14 at its top end. A first clip 16 is attached at the top of the rounded head 14. The first clip 16 has plurality of claws shaped structure that secures the first clip 16 over the rounded head 14. The first clip 16 is used to clip a towel to the rounded head 14. When the towel attached to the first clip 16 is spun using the towel twirling device, the first clip 16 allows the towel to swivel around the rounded head 14, thereby causing the towel to twirl around freely. A second clip 18 is connected on the bottom end of the towel twirling device. The second clip 18 is used to hang the towel twirling device, with the towel clipped on the first clip 16, by connecting the device to a belt loop, pocket, or bottom of the shirt when the towel is not to be twirled.

FIG. 2 illustrates an exemplary representation of another towel twirling device. The rally towel device has a round tube 12 with a rounded head 14 attached to the top end of the round tube 12. A first clip 16 is attached to the top of the rounded head 14. The first clip 16 has a claw shaped structure that secures the first clip 16 over the rounded head 14. The first clip 16 is used to clip a towel to the rounded head 14. The round tube 12 is passed through a hollow cylinder 20 such that the rounded head 14 is present outside of the top end of the hollow cylinder 20. The hollow cylinder functions as a handle. A clip cap 22 is attached to the bottom end of the round tube 12 exiting the bottom end of the hollow cylinder 20. The clip cap 22 holds the round tube 12 inside of the hollow cylinder 20 and prevents it from slipping out. To the clip cap 22, a second clip is connected, which is used to hang the towel twirling device with towel clipped on the first clip 16, by connecting the device to a belt loop, pocket, or bottom of a shirt when the towel is not to be twirled. The hollow cylinder 20 functions as handle for the towel twirling device also has sufficient space for gripping onto it. When the towel attached to the first clip 16 is spun using the towel twirling device, the first clip 16 attached to the rounded head 14 allows the towel attached to the first clip 16 to swivel around the rounded head 14. Furthermore, the round tube 12 rotates inside of the hollow cylinder 20. The swivel movement of towel around the rounded head 14 and the rotation movement of round tube 12 inside the hollow cylinder 20 together cause the towel to twirl around freely.

It is preferred that the towel twirling device, including its round tube, is made of a light-weight material, such as plastic. Furthermore, the round tube is preferably 5 inches to 7 inches long, and ⅜ inches to ¾ inches in diameter. The rally towel that is removably attached to the device with recessed faces for mounting sports team indicia, that may have solid color, multiple colors, colors of teams, designs, logos, characters, cartoons, and textures on it. For example, the rally towel device may be red colored.

The towel twirling device prevents a towel from wrapping around a hand, also the towel is clipped onto the without deformation. Thus, towel twirling is more fun. Also, the towel twirling towel provides a good way to carry towels during sporting events, such as the World Series, Super Bowl, Rose Bowl games, etc. The towel twirling device can be used by fans to attach a usual towel or towel representing their favorite team to the towel twirling device with the provided clip. The towel twirling device can also be used by sports club who can manufacture it with towels customized to represent their sports team for selling or free distribution at sport event.

It is to be understood that the above description is intended to be illustrative, and not restrictive. For example, the above discussed embodiments may be used in combination with each other. Many other embodiments will be apparent to those of skill in the art upon reviewing the above description.

Plural instances may be provided for components, operations or structures described herein as a single instance. Finally, boundaries between various components, operations, and elements are somewhat arbitrary, and particular operations are illustrated in the context of specific illustrative configurations. Other allocations of functionality are envisioned, and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

We claim:

1. A towel twirling device for preventing the towel from wrapping around the hand comprising:
a round tube having a top end, a bottom end, a round head at said top end, and configured to function as a handle;
a first clip connected to said round head and configured to attach a towel such that said towel swivel around said round head; and
a second clip connected to said bottom end of said round tube configured to secure said towel twirling device with clipped towel when towel is not to be twirled.

2. The towel twirling device of claim 1, wherein said towel twirling device further comprises a towel attached to said first clip.

3. The towel twirling device of claim 1, wherein said second clip secure said towel twirling device with clipped towel to a garment worn by a user.

4. The towel twirling device of claim 1, wherein said round tube is made of light weight material.

5. The towel twirling device of claim 1, wherein said round tube is made of plastic.

6. The towel twirling device of claim 1, wherein said first clip of said twirling device comprise of plurality of claws to clip said towel onto said round head of said top end.

7. The towel twirling device of claim 1, wherein said towel is clipped onto said round head without deformation.

8. The towel twirling device of claim 1, wherein said towel is removably clipped onto said round head.

9. The towel twirling device of claim 1, wherein said round tube configured to hang said towel twirling device.

10. The towel twirling device of claim 1, wherein said handle has one or more recessed faces for mounting sports team indicia therein.

11. A towel twirling device for preventing the towel from wrapping around and bundle up around hand comprising:
a hollow cylinder with a top end and a bottom end, configured to function as a handle;
a round tube smaller in diameter and longer than said hollow cylinder having a top end, a bottom end having a round head at said top end; and
rotatably passing through the hollow part of said hollow cylinder such that said round head is present at top end of said hollow cylinder, bottom end of said round tube extends out of bottom end of said hollow cylinder;
a first clip connected to said round head and configured to attach a towel such that said towel swivel around said round head;
a clip cap connected to said bottom end of said round tube and configured to hold said round tube inside the said hollow cylinder and prevent from slipping out;
a second clip connected to said clip cap and configured to secure said towel twirling device with clipped towel when towel is not to be twirled.

12. The towel twirling device of claim 11, wherein said first clip of said twirling device comprise of plurality of claws to clip said towel onto said round head of said top end.

13. The towel twirling device of claim 11, wherein said towel is clipped onto said round head without deformation.

14. The towel twirling device of claim 11, wherein said towel is removably clipped onto said round head.

15. The towel twirling device of claim 11, wherein said second clip secure said towel twirling device with clipped towel to a garment worn by a user.

16. The towel twirling device of claim 11, wherein said round tube configured to hang said towel twirling device.

17. The towel twirling device of claim 11, wherein said round tube is made of light weight material.

18. The towel twirling device of claim 11, wherein said round tube is made of plastic.

19. The towel twirling device of claim 11, wherein said handle providing sufficient space for gripping by a user.

20. The towel twirling device of claim 11, wherein said handle has one or more recessed faces for mounting sports team indicia therein.
